(19) United States
(12) Patent Application Publication
(10) Pub. No.: US 2005/0153598 A1
(43) Pub. Date: Jul. 14, 2005

(54) Connector assembly

(76) Inventors: Douglas L. Meister, Loganville, GA (US); Armono J. Easter, Lawrenceville, GA (US)

Correspondence Address: SCIENTIFIC-ATLANTA, INC.;INTELLECTUAL PROPERTY DEPARTMENT, 5030 SUGARLOAF PARKWAY, LAWRENCEVILLE, GA, 30044, US

(21) Appl. No.: 10/757,173

(22) Filed: Jan. 14, 2004

(51) Int. Cl. H01R 13/60

(52) U.S. Cl. 439/541.5

(57) ABSTRACT

A connector assembly for use in an economy of space. The connector assembly includes a connector housing configured to be received by an electrical system housing. In one embodiment, an IR input connector and an S-video input connector are housed within a connector housing. The IR input connector and the S-video input connector together have a first footprint on a system board within the electrical system housing. A fiber optic input connector is also housed within the connector housing. The fiber optic input connector has a second footprint when coupled to the system board. The first and second footprints communicate with one another on the system board. Electrical leads of the IR input connector and the S-video input connector in the first footprint are displaced from electrical leads of the fiber optic input connector in the second footprint when the IR input connector, the S-video input connector and the fiber optic input connector are coupled to the system board within the electrical system housing.

### CROSS REFERENCE TO RELATED APPLICATIONS

The present U.S. utility application is related to U.S. design application (our Docket No. A-9584) entitled “Connector” and to U.S. design application (our Docket No. A-9585) also entitled “Connector”, both to the same inventors, which are incorporated herein by reference, and having been filed concurrently with the present application.

### TECHNICAL FIELD

The present invention relates to a connector assembly and, more particularly, relates to a connector assembly configured to economize space.

### BACKGROUND OF THE INVENTION

Today's electrical devices are designed to interface with many different input and output (I/O) devices. External I/O devices are typically physically and electrically coupled to an electrical system housing of an electrical device via a connector panel on the electronic device. The connector panel includes numerous I/O connectors that allow the external I/O devices to communicate to an internal electrical system within the electrical system housing. The internal electrical system typically includes a system board that is laid out to accommodate a variety of components. Different mounting contacts are placed on the system board during assembly for communicating to each of the external devices through one of the connectors.

However, the amount of available surface area on a connector panel is limited because of the number of connectors present as well as the arrangement of the connectors relative to one another. The connectors on the connector panel are typically arranged for the non-technical user to interact with. Also, a portion of the available surface area of the connector panel must be set aside for placement of labels that provide information to the consumer. Therefore, the connector panels on today's devices do not have sufficient space to accommodate additional connectors.

What is needed is a reconfiguration of the arrangement of the connectors on the connector panels. In particular, the connectors must be reorganized to economize space while still permitting easy access to the connectors.

### BRIEF DISCRIPTION OF THE DRAWINGS

FIG. 1 illustrates a front perspective view of one embodiment of a connector assembly of the present invention having an IR input connector, an S-video input connector, and a fiber optic input connector.

FIG. 2 is a front view of the connector assembly of FIG. 1.

FIG. 3 illustrates a back perspective view of the connector assembly of FIG. 1.

FIG. 4 illustrates a back perspective view of a prior art subscriber device such as a set-top-box.

FIG. 5 illustrates a front view of a prior art fiber optic input connector.

FIG. 6 illustrates a top view of footprints of prior art components on a system board.

FIG. 7 illustrates a back perspective view of one embodiment of a subscriber device of the present invention utilizing the connector assembly of FIGS. 1-3.

FIG. 8 illustrates a top view of a footprint of the connector assembly of FIGS. 1-3.

FIG. 9 illustrates an exploded view of an alternative embodiment of a connector assembly of the present invention.

FIG. 10 illustrates a top view of an alternative footprint of the present invention.

FIG. 11 illustrates a back perspective view of an alternative embodiment of a subscriber device of the present invention.

### DETAILED DESCRIPTION

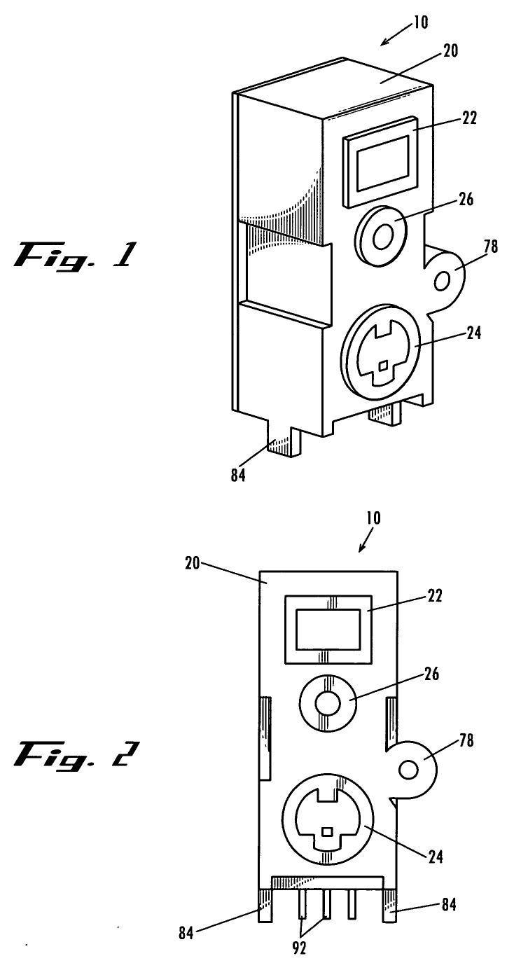

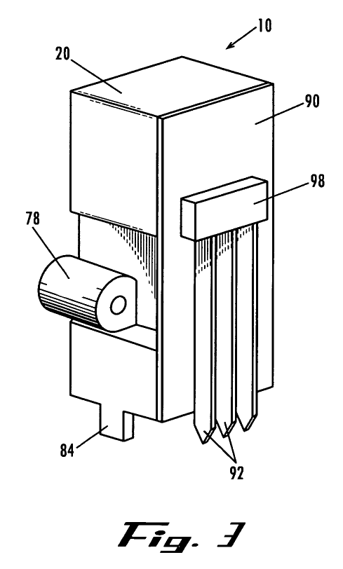

The present invention solves the above-identified problems by providing a connector assembly 10 configured to be utilized in an economy of space. Referring now to the drawings in which like numerals indicate like elements throughout the several views, FIGS. 1-3 illustrate an exemplary embodiment of the connector assembly 10 of the present invention.

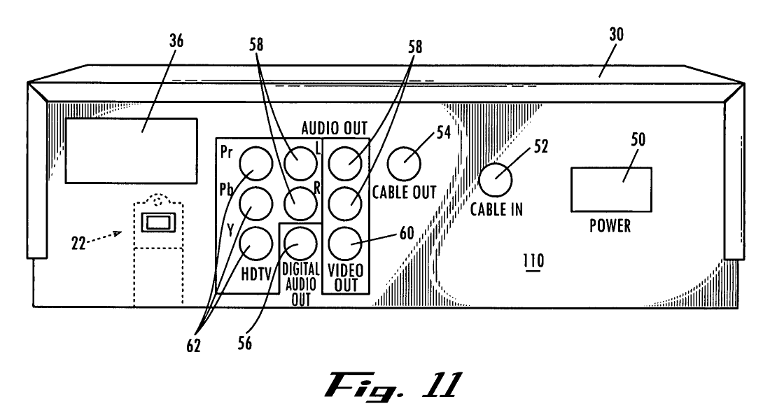

Generally described, the connector assembly 10 includes a connector housing 20 for housing a fiber optic input connector 22 for connecting to a fiber optic cable, a S-video input connector 24 to connect to an S-video input of a television or VCR, and an IR input connector 26 to connect to optional VCR commander service. The connector assembly 10 is configured for use in an economy of space with an electrical system housing 30 (FIG. 7) of an electrical device such as those devices commonly referred to as a subscriber apparatus, subscriber home terminal, home communication terminal, entertainment server, integrated receiver decoder, set-top-box, or an equivalent. The electrical system housing 30 includes an internal electrical system with a system board 32 (FIGS. 8 and 10) manufactured to receive electrical leads from the connector assembly 10. Other circuit boards may be utilized within the electrical system housing 30. The connector housing 20 is configured to be physically received and retained in a connector panel 86 (FIG. 7) of the electrical system housing 30.. The input connectors 22, 24, and 26 of the connector assembly 10 releaseably receive physical and electrical couplings external to the electrical system housing 30.

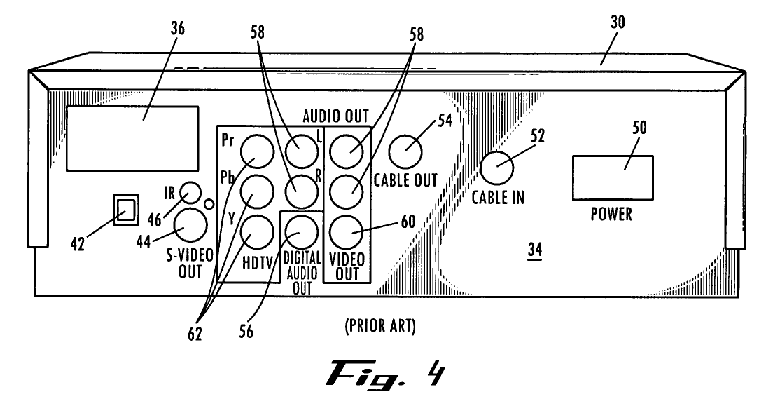

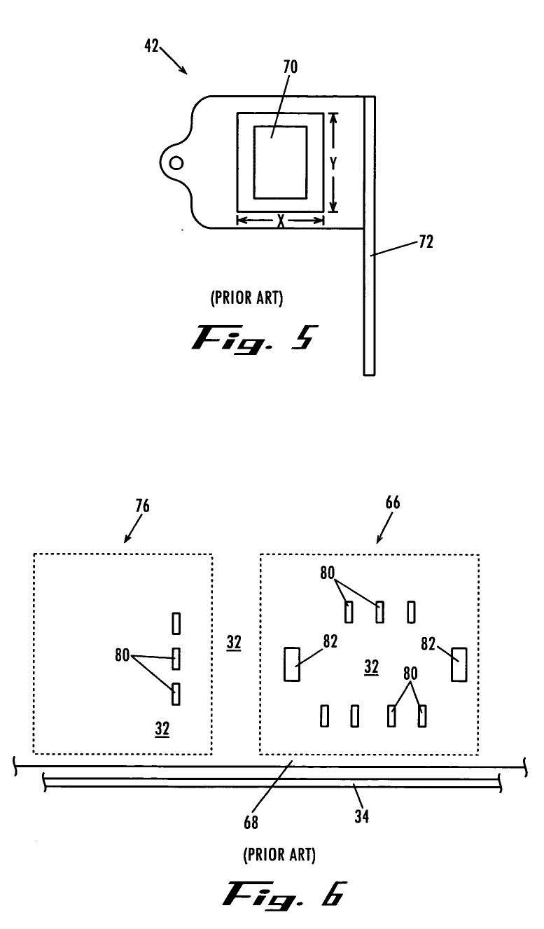

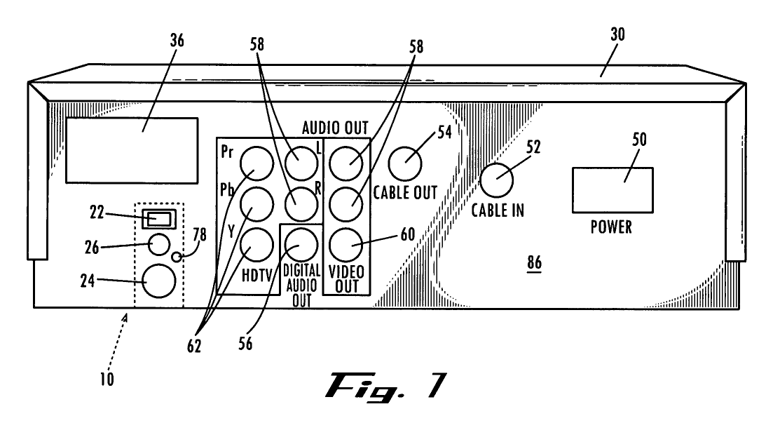

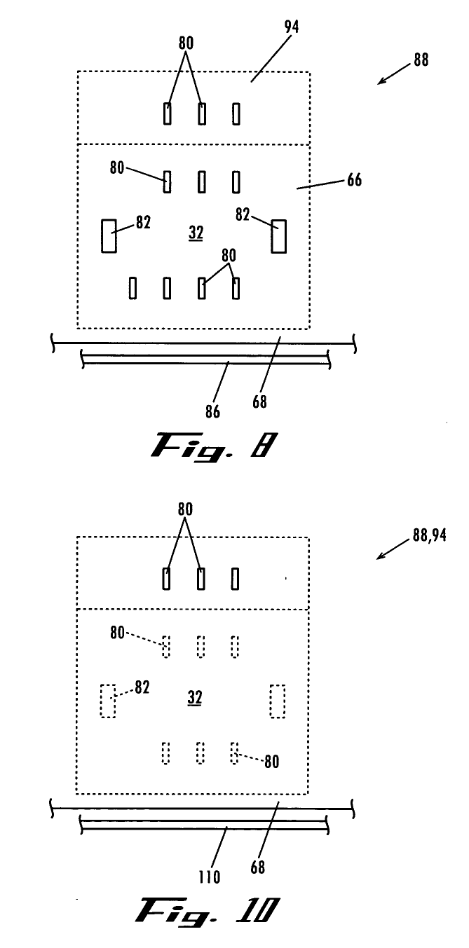

Known devices such as set-top-boxes typically include the I/O connectors generally arranged as shown in FIG. 4. However, connector panels such as connector panel 34 must also provide space for labeling information. Typically, one or more portions of the connector panel 34 are set aside for placement of various types of usefuil information such as a serial number or a bar code. In FIG. 4, in the upper left comer of the connector panel 34, a labeling portion 36 is used for placement of any such information. However, if desired, the labeling portion 36 may instead be placed elsewhere on the connector panel 34. The size and the location of the labeling portion 36 often interferes with the connector's accessibility. Also, the amount of information placed on the labeling portion 36 periodically increases which results in the labeling portion 36 crowding the connectors.

Still referring to FIG. 4, the connector panel 34 includes a fiber optic input connector 42, a S-video input connector 44, and an IR input connector 46, which are all oriented below and in close proximity to the labeling portion 36. The IR input connector 46 is placed above the S-video input connector 44 and, in contrast to the present invention as described in greater detail below, the fiber optic input connector 42 is separately spaced to the left of both the S-video input and the IR input connectors 44, 46.

Set-top-boxes are also known to include an AC power input connector 50 to receive an AC power cord, a cable input connector 52 to connect to a cable signal from a service provider, a cable output connector 54 to connect to a cable input of a standard definition television or VCR. Connector panels may also include a digital audio out connector 56 to connect to an external digital surround-sound receiver, a plurality of L/R audio out connectors 58 to connect to a stereo receiver or a television with stereo sound, a video out connector 60 for use with a corresponding pair of the L/R audio out connectors 58, and HDTV component-video input connectors 62 to connect to a HDTV input of a high definition television along with the other corresponding pair of L/R audio out connectors 58. Connector panels such as those utilized with set-top-boxes may also include other connectors such as USB, Ethernet, and 1394 connectors (not shown) to connect to external devices.

As shown in FIG. 4, it is known to house together the S-video input connector 44 and the IR input connector 46 to form a single connector assembly. Fiber optic input connector 42, as shown in FIG. 5, is housed separately from the S-video input connector 44 and the IR input connector 46. Because the S-video input connector 44 and the IR input connector 46 are housed together, a footprint 66 is defined on the system board 32 as shown in FIG. 6. The footprint 66 of the input connectors 44, 46 is positioned adjacent an edge 68 of the system board 32 which, in turn, is positioned adjacent the connector panel 34.

As shown in FIG. 5, known fiber optic input connector 42 has a receptacle portion 70 that extends from a proximal end of a sister board 72. Connecting pins (not shown) protrude through the side of the sister board 72 opposite the receptacle portion 70. The sister board 72 is elongated in a substantially vertical manner when the distal end of the sister board 72 is connected to the system board 32 to elevate the receptacle portion 70 above the system board 32. A header (not shown) and a matting connector (not shown) are typically used to connect the distal end of the sister board 72 to the system board 32. When connected to the system board 32, the face of the sister board 72 is oriented substantially perpendicular to the connector panel 34. Connecting pins (not shown) also protrude from the distal end of the sister board 72 in order to connect the sister board 72 to the system board 32 via the header and matting connector.

The receptacle portion 70 includes a length x and a length y. In FIG. 5, the length y is the height and the length x is the width Because the length y is longer than the length x, the overall height of the fiber optic input connector 42 is determined, in part, by the length y of the receptacle portion 70. However, if the receptacle portion 70 were turned 90° relative the sister board 72, as in one embodiment of the present invention described in greater detail below, the length x of the receptacle portion 70 would instead determine, in part, the overall height of the fiber optic input connector 42. The overall height of a fiber optic input connector based in part upon the shorter length x, rather than the longer length y, results in a shorter fiber optic input connector.

Because the face of the sister board 72 is oriented perpendicular to the edge 68 of the system board 32 and to one side of the S-video and IR input connectors 44, 46, the fiber optic input connector 42 has a second footprint 76, as best shown in FIG. 6, adjacent the edge 68 of the system board 32. Each footprint 66, 76 circumscribes or surrounds a plurality of contact areas 80 where the pins or jack poles from the leads of the connectors make electrical contact with the system board 32. Each footprint 66, 76 may further circumscribe additional contact areas 82, as does footprint 66, for mechanically fastening the connectors to the system board 32. Contact areas 82 may be small openings in the system board 32 for receiving and retaining portions 84 that extend outwardly from the bottom of the connector housing 20 of the connector assembly 10. Each footprint on the system board may be further defined by the shape of the connector housing overhead to the extent that the configuration of the connector housing may be outlined onto the system board below. In particular, the footprint 76, for the most part, is defined by the receptacle portion 70 overhead, and the sister board 72 from which the receptacle portion 70 extends, rather than merely contact areas 80 and the edge of the vertically-oriented sister board 72.

As shown in FIG. 6, footprint 66 and footprint 76 are laterally displaced from one another on the system board 32 and, therefore, do not communicate with each other. Footprints 66 and 76 do not communicate with each other because the fiber optic input connector 42 is housed separately from the IR and S-video input connectors 44, 46. Also, the footprints 66 and 76 do not communicate with each other because of the connector pins protruding from the sister board 72 that are utilized to connect the receptacle portion 70 to the sister board 72 as well as to connect the distal end of the sister board 72 to the system board 32. The contact areas 80 in footprint 76 are aligned end-to-end with one another in substantially a straight line. Conversely, the footprint 66 has a front row of contact areas 80 and a back row of contact areas 80. The contact areas 80 in each row are preferably arranged in a face-to-face relationship with one another.

Referring back to FIGS. 1-3 depicting an exemplary embodiment of the connector assembly 10 of the present invention, the connector housing 20 is of one-piece construction. Preferably, as shown in FIG. 7, the connector assembly 10 is received in a connector panel 86 of the electrical system housing 30. The connector panel 86 may commonly be referred to as a back panel when external I/O devices are intended to be connected to the back of the electrical system housing 30. The connector assembly 10 is retained in the connector panel 86 by using a mounting hole 78 that preferably extends outward from the housing 20. However, in an alternative embodiment, the connector-housing 20 may instead be of multi-piece construction as described in greater detail below. In such case, additional mounting holes may be required.

Because of the manner in which the input connectors 22, 24 and 26 of the present invention are housed together by the housing 20, the connector assembly 10 provides a single footprint 88, as shown in FIG. 8, that is a substantial improvement over the combination and arrangement of the separate footprints 66, 76 shown in FIG. 6. The footprint 88 is defined by the configuration of the connector assembly 10 of the present invention. As best shown in FIG. 3, the connector assembly 10 includes a back plate 90 coupled to the rear of the connector housing 20. The back plate 90 encloses the leads from the S-video and IR connectors 24, 26 within the housing 20 which extend outwardly from the bottom of the connector assembly 10. However, leads 92 from the fiber optic input connector 22, extend through the back plate 90 to the exterior of the connector housing 20 and then extend down along the length of the back plate 90 to the bottom of the connector assembly 10. A shroud portion 98 may partially obscure from view the point at which the leads 92 extend to the exterior through the back plate 90.

Therefore, the back plate 90 with leads 92 of the fiber optic connector 22 defines a portion of the footprint 88 on the system board 32 in FIG. 8. The portion of footprint 88 defined by the back plate 90 with leads 92 is smaller relative footprint 76 of the fiber optic input connector 42 in FIG. 6. This is because the fiber optic input connector 22 of the present invention partially overlays the S-video and IR input connectors 24, 26. The back plate 90 with leads 92 extends beyond the confines of footprint 66 resulting in a footprint 94. The contact areas 80 in the footprint 94 are aligned face-to-face rather than end-to-end.

Footprint 94 of the fiber optic input connector 22, in combination with the footprint 66 of the input connectors 24, 26, defines the footprint 88. Footprints 66 and 94 overlap or at least border one another and, therefore, communicate with one another as shown in FIG. 8. The footprint 88 is more compact than the combination of the footprints 66, 76 because the wasted space on the system board 32 that exists between footprints 66 and 76, as shown in FIG. 6, has been eliminated. The footprint 94 is relatively elongated in shape and narrow compared to the footprint 76 because the fiber optic input connector 22 overlies the other two input connectors 24, 26. The size of the footprint 94 due to the fiber optic input connector 22 has been significantly reduced because only the back plate 90 and leads 92 define the footprint 94. Therefore, the connector assembly 10 economizes space on the system board 32 as well as on the connector panel 86.

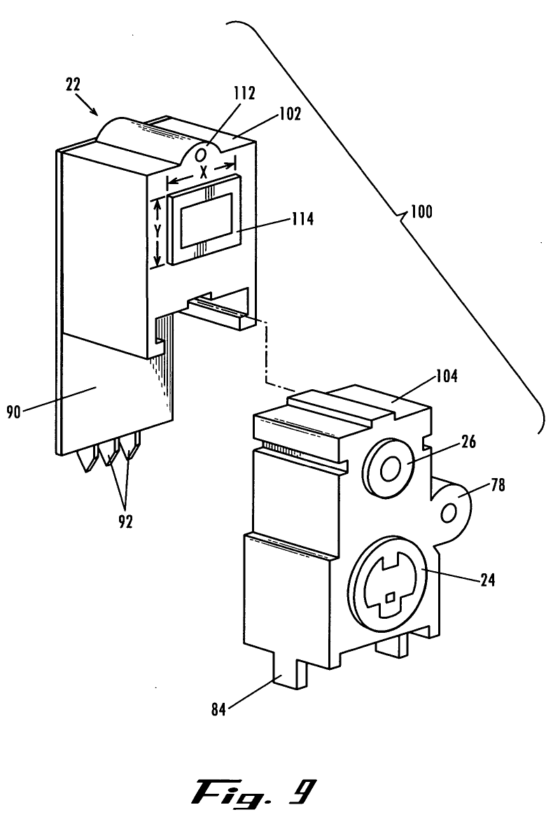

In another embodiment of the present invention, as shown in FIG. 9, a connector assembly 100 includes an upper housing portion 102 and a lower housing portion 104. The connector assembly 100 allows all of the input connectors 22, 24, 26 to be combined together having footprint 88 on the system board or, alternatively, allows either of the housing portions 102 and 104 to be utilized separately if desired. For example, the fiber optic input connector 22 may be utilized separately without the input connectors 24, 26 in the connector panel of the electrical system housing 30 by separating into one housing portion 102 having only the fiber optic input connector 22 and the other housing portion 104 having both the IR and S-video input connectors 24, 26. Because the housing of connector assembly 100 is separable into multiple pieces, upper housing portion 102 may be secured by mounting hole 112 and the lower housing portion 104 may be secured by mounting hole 78. Also, the bottom of the upper housing portion 102 may be mechanically secured to the lower housing portion 104. For example, the upper housing portion 102 may be snap-fitted or slide-fitted to the lower housing portion 104 as shown in FIG. 9.

The fiber optic input connector 22 may be manufactured and utilized separately without being assembled in combination with the input connectors 24, 26. If input connectors 24, 26 are not utilized in the electrical system housing 30, footprint 94 is enlarged as shown in FIG. 10 to correspond with footprint 88 because footprint 94 now encompasses the portion upon the system board 32 that would have been occupied by footprint 66 if the input connectors 24, 26 had been present. Footprint 94 is enlarged because of the configuration of housing portion 102 directly above the system board 32. Housing portion 102 is dimensioned to substantially span the distance between the connector panel and the back plate 90. FIG. 10 illustrates contact areas 80, 82 in phantom upon the system board 32 because the S-video input connector 24 and the IR input connector 26 are not utilized.

Also, because there is no S-video or IR input connectors 24, 26, the electrical system housing 30 may instead include a connector panel 110 as shown in FIG. 11. The connector panel 110 is configured only to accommodate the fiber optic input connector 22. The fiber optic input connector 22 is secured to the connector panel 110 by mounting hole 112 extending from housing portion 102.

A receptacle portion 114 of the connector 22 of the present invention is preferably oriented such that the receptacle's greatest dimension is oriented in a horizontal manner rather than in a vertical manner in order to maximize the available space above the input connector 22. As best shown in FIG. 9, the shorter length y is oriented vertically rather than the longer length x. Therefore, the shorter length y of the receptacle potion 114 determines, in part, when the back plate 90 is a fixed length, the overall height of the input connector 22 that allows the input connector 22 to be utilized in an economy of space.

The foregoing has broadly outlined some of the more pertinent aspects and features of the present invention. These should be construed to be merely illustrative of some of the more prominent features and applications of the invention. Other beneficial results can be obtained by applying the disclosed information in a different manner or by modifying the disclosed embodiments. Accordingly, other aspects and a more comprehensive understanding of the invention may be obtained by referring to the detailed description of the exemplary embodiments taken in conjunction with the accompanying drawings, in addition to the scope of the invention defined by the claims.

1. A connector assembly for use in an economy of space with an electrical system housing having an internal electrical system, said connector assembly releasably receiving physical and electrical couplings external to said electrical system housing, said connector assembly comprising:
a connector housing configured to be received by said electrical system housing;
an IR input connector housed within said connector housing;
an S-video input connector housed within said connector housing, said IR input connector and said S-video input connector together having a first footprint on a system board of said internal electrical system when coupled to said system board; and
a fiber optic input connector housed within said connector housing, said fiber optic input connector having a second footprint when coupled to said system board, said first and second footprints communicating with one another on said system board,
wherein electrical leads of said IR input connector and said S-video input connector in said first footprint are displaced from electrical leads of said fiber optic input connector in said second footprint when said IR input connector, said S-video input connector and said fiber optic input connector are coupled to the internal electrical system within the electrical system housing.

2. The connector assembly of claim 1 wherein said input connectors vertically overlay one another.

3. The connector assembly of claim 1 wherein said connector housing is substantially one-piece construction and wherein a portion of said connector housing physically coupling said fiber optic input connector is integrally formed with a portion of said connector housing physically coupling said IR input connector and said S-video input connector.

4. The connector assembly of claim 1 wherein said first footprint on said system board is positioned substantially between an edge of said system board and said second footprint on said system board.

5. The connector assembly of claim 1 wherein said first footprint on said system board is positioned adjacent an edge of said system board and said second footprint is displaced from the edge of said system board behind said first footprint.

6. The connector assembly of claim 1 wherein said connector housing is received in a connector panel of said electrical system housing, and wherein said first footprint is positioned adjacent said connector panel and an edge of said system board, and said second footprint is displaced from said connector panel behind said first footprint.

7. The connector assembly of claim 1 wherein said fiber optic input connector housed within said connector housing overlies said IR and S-video input connectors housed by said connector housing and said first and second footprints are adjacent one another.

8. The connector assembly of claim 1 wherein said connector housing includes a front and rear, said electrical leads of said fiber optic input connector extending to the exterior of said connector housing through said rear of said connector housing to at least partially define said second footprint on said system board.

9. The connector assembly of claim 8 wherein said connector housing includes a back plate coupled to said rear of said connector housing, said electrical leads of said fiber optic input connector extending through said back plate to the exterior of said connector housing.

10. The connector assembly of claim 1 wherein said fiber optic input connector comprises a receptacle portion to receive and retain a disconnectable mechanical plug on an end of a fiber optic cable, said receptacle portion elongated in a horizontal manner when said connector assembly is retained in the electrical system housing to maximize vertical space on a connector panel of said electrical system housing.

11. The connector assembly of claim 1 wherein said fiber optic input connector comprises a receptacle portion to receive and retain a disconnectable mechanical plug on an end of a fiber optic cable, said receptacle portion having a length x greater than a lengthy, and said length x of said receptacle portion of said fiber optic input connector oriented in a substantially horizontal manner to maximize vertical space on a connector panel of said electrical system housing.

12. The connector assembly of claim 1 wherein said connector housing is formed from multi-piece construction such that said connector housing separately encloses said fiber optic input connector and separately encloses together said IR and S-video input connectors, wherein said fiber optic input connector can be detached from said S-video and IR input connectors.

13. The connector assembly of claim 1 wherein said IR input connector, said S-video input connector and said fiber optic input connector are physically and electrically coupled to said system board without an add-on-board.

14. In a device comprising an electrical system housing having an internal electrical system, a connector assembly adapted to be received and retained in an economy of space by said device, said connector assembly for releasably receiving physical and electrical couplings external to said electrical system housing, said connector assembly comprising:
a connector housing configured to be received by said electrical system housing;
an IR input connector housed within said connector housing;
an S-video input connector housed within said connector housing, said IR input connector and said S-video input connector together having a first footprint on a system board of said internal electrical system when coupled to said system board; and
a fiber optic input connector housed within said connector housing, said fiber optic input connector having a second footprint on said system board when coupled to said system board, said first and second footprints on said system board communicating with one another,
wherein electrical leads of said IR input connector and said S-video input connector in said first footprint are displaced from electrical leads of said fiber optic input connector in said second footprint when said IR input connector, said S-video input connector and said fiber optic input connector are coupled to said internal electrical system within said electrical system housing of said subscriber device.

15. The subscriber device of claim 14 wherein said device is a set-top-box.

16. A connector assembly comprising a connector assembly for use in an economy of space with a connector panel of an electrical system housing having an internal electrical system, said connector assembly for releasably receiving physical and electrical couplings external to the electrical system housing, said connector assembly comprising:
a connector housing configured to be received and retained in said connector panel of said electrical system housing;
an IR input connector housed within said connector housing;
an S-video input connector housed within said connector housing, said IR input connector and said S-video input connector together having a first footprint when coupled to a system board of said internal electrical system; and
a fiber optic input connector housed within said connector housing, said fiber optic input connector having a second footprint when coupled to said system board of said internal electrical system, said first and second footprints communicating with one another,
wherein said input connectors are housed together in said connector housing to permit maximum vertical spacing on said connector panel of said electrical system housing.

17. The connector interface of claim 16 wherein said first footprint is positioned adjacent both said connector panel, and said second footprint is displaced from said connector panel behind said first footprint.

18. The connector interface of claim 15 wherein said fiber optic input connector comprises a receptacle portion to receive and retain a disconnectable mechanical plug on an end of a fiber optic cable, said receptacle portion elongated in a horizontal manner when said connector assembly is retained in said electrical system housing.

19. A connector assembly for use in an economy of space with an electrical system housing having an internal electrical system, said connector assembly releasably receiving physical and electrical couplings external to said electrical system housing, said connector assembly comprising:
a connector housing configured to be received by said electrical system housing;
a first connector housed within said connector housing;
a second connector housed within said connector housing, said first and second connectors together having a first footprint on a circuit board of said internal electrical system when coupled to said system board; and
a third connector housed within said connector housing, said third connector having a second footprint when coupled to said circuit board, said first and second footprints communicating with one another on said circuit board,
wherein electrical leads of said first and second connectors in said first footprint are displaced from electrical leads of said third connector in said second footprint when coupled to the internal electrical system within the electrical system housing.

20. A connector assembly for use in an economy of space with an electrical system housing having an internal electrical system, said connector assembly releasably receiving physical and electrical couplings external to said electrical system housing, said connector assembly comprising:
a first connector housed within said connector assembly, said first connector having a first footprint on a circuit board of said internal electrical system when coupled to said system board; and
a second connector housed within said connector assembly, said second connector having a second footprint when coupled to said circuit board, said first and second footprints communicating with one another on said circuit board,
wherein electrical leads of said first connector in said first footprint are displaced from electrical leads of said second connector in said second footprint when coupled to the internal electrical system within the electrical system housing.
